(19) United States
(12) Patent Application Publication
(10) Pub. No.: US 2025/0326661 A1
(43) Pub. Date: Oct. 23, 2025

(54) METHOD AND SYSTEM FOR TREATING WASTEWATER FROM THERMAL POWER PLANT

(71) Applicant: YANTAI POWER PLANT OF HUANENG SHANDONG POWER GENERATION CO., LTD., YANTAI (CN)

(72) Inventors: BINGLIANG YANG, YANTAI (CN); LIKUN ZHENG, YANTAI (CN)

(73) Assignee: YANTAI POWER PLANT OF HUANENG SHANDONG POWER GENERATION CO., LTD., YANTAI (CN)

(21) Appl. No.: 19/062,089

(22) Filed: Feb. 25, 2025

(30) Foreign Application Priority Data
Apr. 19, 2024 (CN) 202410472245.8

(51) Int. Cl. C02F 1/00; C02F 103/34

(52) U.S. Cl. CPC C02F 1/008; B01D 61/12; B01J 49/85; C02F 1/42; C02F 1/441; F15B 19/007; G05B 13/04; C02F 2103/34; C02F 2209/001; C02F 2209/006

(57) ABSTRACT

The disclosure relates to the technical field of thermal power plant wastewater, in particular to a method and system for treating wastewater from thermal power plant. The method includes: building a plurality of wastewater sub-regions, and generating pollution evaluation values according to historical parameters of the wastewater sub-regions; setting cycle grade and monitoring time nodes of each of the wastewater sub-regions according to the pollution evaluation values, and obtaining water quality monitoring parameters of the wastewater sub-regions according to the monitoring time nodes; building a wastewater control model among the wastewater sub-regions, and setting wastewater treatment parameters of each of the wastewater sub-regions according to the wastewater control model and the water quality monitoring parameters.

### CROSS-REFERENCE TO RELATED APPLICATIONS

This application claims priority of Chinese Patent Application No. 202410472245.8, filed on Apr. 19, 2024, the content of which is hereby incorporated by reference.

### TECHNICAL FIELD

The disclosure relates to the technical field of thermal power plant wastewater, in particular to a method and system for treating wastewater from thermal power plant.

### BACKGROUND

The main wastewater discharged from thermal power plants includes ash yard drainage, industrial wastewater and domestic sewage, among which industrial wastewater can be divided into recurrent wastewater and non-recurrent wastewater. Recurrent wastewater refers to wastewater discharged continuously or intermittently in a day, such as wastewater from flue gas desulfurization system, drainage from domestic and industrial pretreatment system, reclaimed water from boiler make-up water treatment, drainage from coal conveying system flushing coal yard, etc. Non-recurring wastewater is the wastewater that is overhauled in a specified period or sent irregularly.

Compared with industrial wastewater such as chemical industry and papermaking, the wastewater from thermal power plants has the following characteristics: the water quality and quantity are very different, and there are many types of divided wastewater. The pollutants in wastewater are mainly inorganic substances, and the organic pollutants are mainly oil. There is more intermittent drainage. However, at present, when treating wastewater in thermal power plants, different wastewater types are treated separately, resulting in great waste of water resources.

### SUMMARY

The purpose of the disclosure is to solve the above technical problems, and the disclosure provides a method and a system for treating wastewater in thermal power plants, aiming at improving the wastewater treatment efficiency of thermal power plants and reducing the waste of water resources.

In some embodiments of the disclosure, multiple wastewater points are set according to the process flow of the thermal power plant, and each wastewater point is classified according to the degree of wastewater pollution, so that the water in the thermal power plant is managed in a unified way, and the discharge amount of wastewater in the whole plant area is reduced, thereby reducing the water cost of the thermal power plant.

In some embodiments of the disclosure, by dividing the three-level circulation sub-regions, the cascade utilization is realized according to the water quality classification and reuse of different wastewater. Through the recycling of wastewater, the recovery rate is improved, and the water supply in the plant area is reduced, thus reducing the operation and maintenance cost within the plant area.

In some embodiments of the disclosure, a method for treating wastewater from a thermal power plant is provided, and includes:
building multiple wastewater sub-regions, and generating pollution evaluation values according to historical parameters of the wastewater sub-regions;
setting cycle grade and monitoring time nodes of each of the wastewater sub-regions according to the pollution evaluation values, and obtaining water quality monitoring parameters of the wastewater sub-regions according to the monitoring time nodes;
building a wastewater control model among the wastewater sub-regions, and setting wastewater treatment parameters of each of the wastewater sub-regions according to the wastewater control model and the water quality monitoring parameters.

In some embodiments of the disclosure, generating pollution evaluation values includes:
building a wastewater sub-region sequence A, and A=(a1, a2 . . . an), where n is a number of the wastewater sub-regions and ai is i-th wastewater sub-region;
building multiple water quality evaluation indexes;
sequentially selecting target wastewater sub-regions, and building a reference evaluation value sequence B of the target wastewater sub-regions according to historical parameters of the target wastewater sub-regions, and B=(b1, b2 . . . bm), where bi is a reference evaluation value corresponding to i-th water quality evaluation index in wastewater of the target wastewater sub-regions, and m is a number of water quality evaluation indexes;
generating a pollution evaluation value c of the target wastewater sub-regions according to the reference evaluation value sequence B;
c=Σ₁^{i=m}βi*bi, where βi is influence factor of i-th water quality evaluation index;
In some embodiments of the disclosure, setting cycle grade of each of the wastewater sub-regions includes:
building a pollution evaluation value sequence C, and C=(c1, c2 . . . cn), where ci is a pollution evaluation value of i-th wastewater sub-region;
presetting a first pollution evaluation value threshold C1 and a second pollution evaluation value threshold C2, and C1<C2;
if ci<C1, setting the i-th wastewater sub-region as a primary circulation sub-region;
if C1≤ci≤C2, setting the i-th wastewater sub-region as a secondary circulation sub-region;
if ci≥C2, setting the i-th wastewater sub-region as a three-level circulation sub-region;
In some embodiments of the disclosure, building a wastewater control model among the wastewater sub-regions includes:
building a wastewater flow direction relationship tree according to device parameters and cycle grade of each of the wastewater sub-regions;
building a primary wastewater model, and setting wastewater parameters of each of primary circulation sub-regions according to the primary wastewater model;
building a secondary wastewater model, and setting wastewater treatment parameters of each of secondary circulation sub-regions according to the secondary wastewater model;
building a three-level wastewater model, and setting wastewater treatment parameters of each of three-level circulation sub-regions according to the three-level wastewater model.

In some embodiments of the disclosure, setting wastewater parameters of each of primary circulation sub-regions including:
building a primary circulation sub-region sequence A1, and A1=(a₁₁, a₁₂ . . . a₁ₙ₁), where a₁ᵢ is i-th primary circulation sub-region and n1 is a number of primary circulation sub-regions;
sequentially selecting target primary circulation sub-regions;
generating a cycle period of the target primary circulation sub-regions according to monitoring time nodes of the target primary circulation sub-regions;
building a pollutant accumulation model, and generating a cycle number interval (e1, e2) of the target primary circulation sub-regions according to the pollutant accumulation model, where e1 is a first cycle number and e2 is a second cycle number;
when wastewater cycle number E1<e<E2 in the target primary circulation sub-regions, generating primary wastewater discharge amount Q1 in the target primary circulation sub-regions;
obtaining a next node region of the target primary circulation sub-regions according to the wastewater flow direction relationship tree, and generating primary wastewater demand Q2 of the next node region of the target primary circulation sub-regions;
if Q1<Q2, transporting all primary wastewater in the target primary circulation sub-regions is to next node region, and resetting wastewater circulation number e;
if Q1>Q2, transporting primary wastewater in the target primary circulation sub-regions to the next node region according to the primary wastewater demand Q2;
when the wastewater cycle number e>E2 in the target primary circulation sub-regions, generating a primary storage instruction.

In some embodiments of the disclosure, setting wastewater treatment parameters of each of secondary circulation sub-regions including:
building a secondary circulation sub-region sequence A2, and A2=(a₂₁, a₂₂ . . . a₂ₙ₂), where n2 is a number of secondary circulation sub-regions and a₂ᵢ is i-th secondary circulation sub-region;
sequentially selecting target secondary circulation sub-regions;
obtaining water quality monitoring parameters according to monitoring time nodes of the target secondary circulation sub-regions, and generating secondary wastewater amount P2 and secondary wastewater pollution degree of the target secondary circulation sub-regions;
obtaining a previous node region and a next node region of each of the target secondary circulation sub-regions according to the wastewater flow direction relationship tree;
obtaining primary wastewater supply P1 of the previous node region and the third-level wastewater demand P3 of the next node region;
generating multiple secondary wastewater initial distribution plans from primary wastewater supply P1, the secondary wastewater amount P2 and the third-level wastewater demand P3 according to a preset constraint model;
building a cost optimization model, and generating expected cost of each of the secondary wastewater initial distribution plans according to the cost optimization model;
building a expected cost sequence F, and F=(f₁, f₂ . . . fₘ₁), where m1 is a number of the secondary wastewater initial distribution plans and fᵢ is i-th secondary wastewater initial distribution plan.

In some embodiments of the disclosure, generating multiple secondary wastewater initial distribution plans includes:
building a constraint model:

$$\{ \begin{matrix}r 1 + r 2 = P 2 \\ r 1 + r 3 + y 1 \geq P 2 \\ r 3 \leq P 1 \\ r 2 + y 2 \geq P 3\end{matrix} ;$$

where r1 is a secondary wastewater amount performing circulation and r2 is a secondary wastewater amount flowing to next node region; r3 is a primary wastewater amount flowing to secondary circulation region; y1 is a compensation water amount to be injected into the target secondary circulation sub-regions, and y2 is a compensation water amount to be injected into the next node region;
setting a unit distribution water amount r, and solving constraint equation according to the unit distribution water amount r;
generating one of the secondary wastewater initial distribution plans according to single group feasible solutions of r1, r2, r3, y1 and y2.

In some embodiments of the disclosure, generating expected cost of each of the secondary wastewater initial distribution plans includes:

$$fi = h {1}^{*} {r}_{1 i} + h {2}^{*} {r}_{2 i} + k {1}^{*} {y}_{1 {i}^{*}} h 3 + k {2}^{*} {y}_{2 {i}^{*}} h 3 ;$$

where fi is expected cost of i-th secondary wastewater initial distribution plan, h1 is primary decontamination cost of secondary wastewater in unit distribution water amount r, and r₁ᵢ is a value of r1 corresponding to i-th secondary wastewater initial distribution plan; h2 is secondary decontamination cost of secondary wastewater in the unit distribution water amount r; r₂ᵢ is a value of r2 corresponding to the i-th secondary wastewater initial distribution plan; k1 is a first penalty coefficient, k2 is a second penalty coefficient, and y₁ᵢ is a value of y1 corresponding to the i-th secondary wastewater initial distribution plan; y₂ᵢ is a value of y2 corresponding to the i-th secondary wastewater initial distribution plan; h3 is cost of make-up water in unit distribution water amount r.

In some embodiments of the disclosure, a system for treating wastewater from a thermal power plant is provided and includes:
a central control unit, used for building multiple wastewater sub-regions and generating pollution evaluation values according to historical parameters of the wastewater sub-regions;
a monitoring unit, used for setting cycle grade and monitoring time nodes of each of the wastewater sub-regions according to the pollution evaluation values,
where the monitoring unit is further used for obtaining water quality monitoring parameters of the wastewater sub-regions according to the monitoring time nodes;
where the central control unit includes:
a first treatment module, used for generating pollution evaluation values;
a second treatment module, used for setting cycle grade of each of the wastewater sub-regions;
a third treatment module, used for building a wastewater control model among the wastewater sub-regions, and setting wastewater treatment parameters of each of the wastewater sub-regions according to the wastewater control model and the water quality monitoring parameters;
where the first treatment module is further used for:
building a wastewater sub-region sequence A, and A=(a1, a2 . . . an), where n is a number of the wastewater sub-regions and ai is i-th wastewater sub-region;
building multiple water quality evaluation indexes;
sequentially selecting target wastewater sub-regions, and building a reference evaluation value sequence B of the target wastewater sub-regions according to historical parameters of the target wastewater sub-regions, and B=(b1, b2 . . . bm), where bi is a reference evaluation value corresponding to i-th water quality evaluation index in wastewater of the target wastewater sub-regions, and m is a number of water quality evaluation indexes;
generating a pollution evaluation value c of the target wastewater sub-regions according to the reference evaluation value sequence B;

$$c = {\sum }_{1}^{i = m} β i * bi ,$$

where β1 is influence factor of i-th water quality evaluation index;
where the second treatment module is further used for:
building a pollution evaluation value sequence C, and C=(c1, c2 . . . cn), where ci is a pollution evaluation value of i-th wastewater sub-region;
presetting a first pollution evaluation value threshold C1 and a second pollution evaluation value threshold C2, and C1<C2;
if ci<C1, setting the i-th wastewater sub-region as a primary circulation sub-region;
if C1≤ci<C2, setting the i-th wastewater sub-region as a secondary circulation sub-region;
if ci≥C2, setting the i-th wastewater sub-region as a three-level circulation sub-region.

In some embodiments of the disclosure, the third treatment module is further used for:
building a wastewater flow direction relationship tree according to device parameters and cycle grade of each of the wastewater sub-regions;
building a primary wastewater model, and setting wastewater parameters of each of primary circulation sub-regions according to the primary wastewater model;
building a secondary wastewater model, and setting wastewater treatment parameters of each of secondary circulation sub-regions according to the secondary wastewater model;
building a three-level wastewater model, and setting wastewater treatment parameters of each of three-level circulation sub-regions according to the three-level wastewater model.

Compare with that prior art, the method and the system for treating wastewater of a thermal power plant in the embodiment of the disclosure have the beneficial effects that.

According to the process flow of the thermal power plant, multiple wastewater points are set, and the wastewater points are classified according to the degree of wastewater pollution, so that the internal water of the thermal power plant is managed in a unified way, and the wastewater discharge in the whole plant area is reduced, thereby reducing the water cost of the thermal power plant.

By dividing the three-level circulation sub-regions, the cascade utilization is realized according to the water quality classification and reuse of different wastewater. Through the recycling of wastewater, the recovery rate is improved, and the water supply in the plant area is reduced, thus reducing the operation and maintenance cost within the plant area.

### BRIEF DESCRIPTION OF THE DRAWINGS

FIG. 1 is a schematic flow diagram of a method for treating wastewater from a thermal power plant in a preferred embodiment according to an embodiment of the disclosure.

### DETAILED DESCRIPTION OF THE EMBODIMENTS

In the following, the specific embodiments of the disclosure will be further described in detail with the attached drawings and embodiments. The following embodiments are used to illustrate this disclosure, but are not used to limit the scope of this disclosure.

In the description of this disclosure, it should be understood that the azimuth or positional relationship indicated by the terms “center”, “up”, “down”, “front”, “back”, “left”, “right”, “vertical”, “horizontal”, “top”, “bottom”, “inside” and “outside” is based on the azimuth or positional relationship shown in the attached drawings, only for the convenience of describing this disclosure and simplifying the description, and does not indicate or imply that the referred device or element must have a specific orientation, be constructed and operated in a specific orientation, so it cannot be understood as a limitation of this disclosure.

The terms “first” and “second” are only used for descriptive purposes, and cannot be understood as indicating or implying relative importance or implicitly indicating the number of indicated technical features. Therefore, the features defined as “first” and “second” may include one or more of these features explicitly or implicitly. In the description of this disclosure, unless otherwise specified, “multiple” means two or more.

In the description of this disclosure, it should be noted that unless otherwise specified and limited, the terms “installation”, “connecting” and “connection” should be broadly understood, for example, they can be fixed connection, detachable connection or integrated connection. They can be mechanical connection or electrical connection. They can be directly connected, can also be indirectly connected through an intermediate medium, and can be connected inside two elements. For those skilled in the art, the specific meanings of the above terms in this disclosure can be understood in specific circumstances.

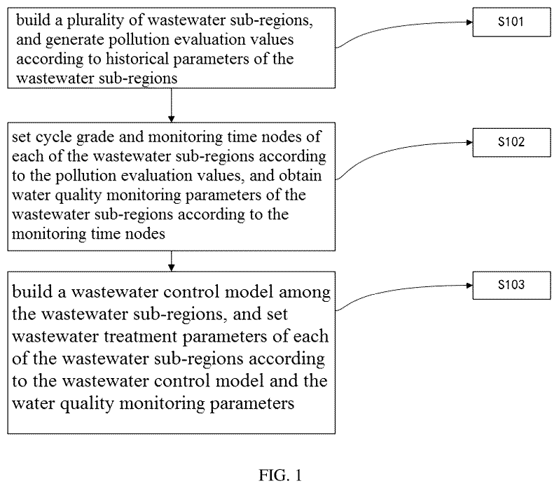

As shown in FIG. 1, a method for treating wastewater from a thermal power plant in a preferred embodiment in the embodiments of the disclosure includes:
S101: multiple wastewater sub-regions are built, and pollution evaluation values are generated according to historical parameters of the wastewater sub-regions;
S102: cycle grade and monitoring time nodes of each of the wastewater sub-regions are set according to the pollution evaluation values, and water quality monitoring parameters of the wastewater sub-regions are obtained according to the monitoring time nodes;
S103: a wastewater control model among the wastewater sub-regions is built, and wastewater treatment parameters of each of the wastewater sub-regions are set according to the wastewater control model and the water quality monitoring parameters.

Specifically, generating pollution evaluation values includes:
a wastewater sub-region sequence A is built, and A=(a1, a2 . . . an), where n is a number of the wastewater sub-regions and ai is i-th wastewater sub-region;
multiple water quality evaluation indexes are built;
target wastewater sub-regions are sequentially selected, and a reference evaluation value sequence B of the target wastewater sub-regions is built according to historical parameters of the target wastewater sub-regions, and B=(b1, b2 . . . bm), where bi is a reference evaluation value corresponding to i-th water quality evaluation index in wastewater of the target wastewater sub-regions, and m is a number of water quality evaluation indexes.

Specifically, according to the internal production process and water demand of thermal power plant, each sub-region producing wastewater is divided, so as to build the wastewater sub-region sequence.

a pollution evaluation value c of the target wastewater sub-regions is generated according to the reference evaluation value sequence B;

$$c = {\sum }_{1}^{i = m} β i * bi ,$$

where βi is influence factor of i-th water quality evaluation index.

Specifically, water quality evaluation index refers to impurities existing in wastewater, such as salt content, suspended solids, heavy metals, etc. According to the influence of different impurities on water quality and the historical average content of impurities, the reference evaluation value corresponding to each of the water quality evaluation indexes is generated.

Specifically, according to the influence of different impurities on water quality, the corresponding influence factor is set, and the evaluation accuracy of the pollution evaluation value is further improved by setting the influence factor. The higher the pollution evaluation value, the worse the wastewater quality in the current wastewater sub-region. The less likely it is to be recycled.

Specifically, setting cycle grade of each of the wastewater sub-regions includes:
a pollution evaluation value sequence C is built, and C=(c1, c2 . . . cn), where ci is a pollution evaluation value of i-th wastewater sub-region;
a first pollution evaluation value threshold C1 and a second pollution evaluation value threshold C2 are preset, and C1<C2;
if ci<C1, the i-th wastewater sub-region is set as a primary circulation sub-region;
if C1≤ci<C2, the i-th wastewater sub-region is set as a secondary circulation sub-region;
if ci≥C2, the i-th wastewater sub-region is set as a three-level circulation sub-region.

Specifically, the first pollution evaluation threshold C1 and the second pollution evaluation threshold C2 are set according to historical parameters, and the primary circulation sub-region refers to the wastewater with less pollutants and impurities, and the water quality can be restored to the use standard after simple treatment, such as miscellaneous drainage of units, drainage of industrial cooling water system, domestic sewage, etc.

Specifically, the secondary circulation sub-region refers to the wastewater with more pollutants and impurities and complicated treatment, or the wastewater with special pollutant components due to the process flow, such as concentrated reverse osmosis drainage and ion exchange device regeneration wastewater.

Specifically, the three-level circulation sub-region refers to the wastewater that cannot be recycled and is directly discharged after treatment reaches the standard. The treatment cost of this kind of wastewater is high and the recovery amount is small such as desulfurization wastewater. Some intermittent wastewater, such as chemical cleaning wastewater, air preheater flue gas side washing wastewater, etc.

Specifically, in the above embodiment, by building three-level circulation sub-regions, the cascade utilization is realized according to the water quality classification and reuse of different wastewater, the recovery rate is improved through wastewater recycling, and the water replenishment amount in the plant area is reduced, thus reducing the operation and maintenance cost inside the plant area.

In a preferred embodiment of the embodiments of the disclosure, building a wastewater control model among the wastewater sub-regions includes:
a wastewater flow direction relationship tree is built according to device parameters and cycle grade of each of the wastewater sub-regions,
specifically, according to the wastewater quality parameters of different wastewater sub-regions, the relationship tree of wastewater flow direction is built, in which the treated wastewater quality of the previous node region must fully meet the water demand of the next node region.

A primary wastewater model is built, and wastewater parameters of each of primary circulation sub-regions are set according to the primary wastewater model;

specifically, a primary circulation sub-region sequence A1 is built, and A1=(a₁₁, a₁₂ . . . a₁ₙ₁), where a₁ᵢ is i-th primary circulation sub-region and n1 is a number of primary circulation sub-regions;
target primary circulation sub-regions are sequentially selected;
a cycle period of the target primary circulation sub-regions is generated according to monitoring time nodes of the target primary circulation sub-regions;
a pollutant accumulation model is built, and a cycle number interval (e1, e2) of the target primary circulation sub-regions is generated according to the pollutant accumulation model, where e1 is a first cycle number and e2 is a second cycle number;
when wastewater cycle number E1<e<E2 in the target primary circulation sub-regions, primary wastewater discharge amount Q1 in the target primary circulation sub-regions is generated;
a next node region of the target primary circulation sub-regions is obtained according to the wastewater flow direction relationship tree, and primary wastewater demand Q2 of the next node region of the target primary circulation sub-regions is generated;
if Q1<Q2, all primary wastewater in the target primary circulation sub-regions is is transported to next node region, and wastewater circulation number e is reset;
if Q1>Q2, primary wastewater in the target primary circulation sub-regions is transported to the next node region according to the primary wastewater demand Q2;
when the wastewater cycle number e>E2 in the target primary circulation sub-regions, a primary storage instruction is generated.

Specifically, pollutants will accumulate in the process of circulation treatment wastewater in the primary circulation sub-region, so the corresponding pollutant accumulation model is set according to the historical parameters of different primary circulation sub-regions, so as to predict the circulation times of wastewater in the primary wastewater sub-region and avoid affecting the production efficiency of thermal power plants due to water quality problems.

Specifically, when the lowest number of cycles is reached, the wastewater demand Q2 of the secondary circulation sub-region is obtained, and it is judged whether the primary wastewater continues to be recycled or flows to the next node.

Specifically, when the number of cycles of the primary wastewater reaches the maximum number of cycles, if the next node region does not need to replenish water at this time, the current primary wastewater will be stored to facilitate the subsequent use of the next node region, thus realizing the multi-level recycling of wastewater and reducing the overall water consumption inside the thermal power plant.

In the preferred embodiment of the embodiment of the disclosure, it further includes:
a secondary wastewater model is built, and wastewater treatment parameters of each of secondary circulation sub-regions are set according to the secondary wastewater model;
a three-level wastewater model is built, and wastewater treatment parameters of each of three-level circulation sub-regions are set according to the three-level wastewater model.

Specifically, according to the three-level wastewater model, the wastewater treatment process of the three-level circulation sub-region is set, and the wastewater is discharged after the treatment reaches the standard.

Specifically, setting wastewater treatment parameters of each of secondary circulation sub-regions includes:
a secondary circulation sub-region sequence A2 is built, and A2=(a₂₁, a₂₂ . . . a₂ₙ₂), where n2 is a number of secondary circulation sub-regions and a₂ᵢ is i-th secondary circulation sub-region;
target secondary circulation sub-regions are sequentially selected;
water quality monitoring parameters are obtained according to monitoring time nodes of the target secondary circulation sub-regions, and secondary wastewater amount P2 and secondary wastewater pollution degree of the target secondary circulation sub-regions are generated;
a previous node region and a next node region of each of the target secondary circulation sub-regions are obtained according to the wastewater flow direction relationship tree;
primary wastewater supply P1 of the previous node region and the third-level wastewater demand P3 of the next node region are obtained;
multiple secondary wastewater initial distribution plans are generated from primary wastewater supply P1, the secondary wastewater amount P2 and the third-level wastewater demand P3 according to a preset constraint model;
a cost optimization model is built, and expected cost of each of the secondary wastewater initial distribution plans is generated according to the cost optimization model;
a expected cost sequence F is built, and F=(f₁, f₂ . . . fₘ₁), where m1 is a number of the secondary wastewater initial distribution plans and fᵢ is i-th secondary wastewater initial distribution plan.

Specifically, generating multiple secondary wastewater initial distribution plans includes:
a constraint model is built:

$$\{ \begin{matrix}r 1 + r 2 = P 2 \\ r 1 + r 3 + y 1 \geq P 2 \\ r 3 \leq P 1 \\ r 2 + y 2 \geq P 3\end{matrix} ;$$

where r1 is a secondary wastewater amount performing circulation and r2 is a secondary wastewater amount flowing to next node region; r3 is a primary wastewater amount flowing to secondary circulation region; y1 is a compensation water amount to be injected into the target secondary circulation sub-regions, and y2 is a compensation water amount to be injected into the next node region;
a unit distribution water amount r is set, and constraint equation is solved according to the unit distribution water amount r;
one of the secondary wastewater initial distribution plans is generated according to single group feasible solutions of r1, r2, r3, y1 and y2.

Specifically, multiple feasible solutions are generated by setting the unit distribution amount r, thus reducing the calculation amount in the solution process and ensuring the decision-making efficiency of the secondary wastewater flow direction.

Specifically, generating expected cost of each of the secondary wastewater initial distribution plans includes:

$$fi = h {1}^{*} {r}_{1 i} + h {2}^{*} {r}_{2 i} + k {1}^{*} {y}_{1 {i}^{*}} h 3 + k {2}^{*} {y}_{2 {i}^{*}} h 3 ;$$

where fi is expected cost of i-th secondary wastewater initial distribution plan, h1 is primary decontamination cost of secondary wastewater in unit distribution water amount r, and r₁ᵢ is a value of r1 corresponding to i-th secondary wastewater initial distribution plan; h2 is secondary decontamination cost of secondary wastewater in the unit distribution water amount r; r₂ᵢ is a value of r2 corresponding to the i-th secondary wastewater initial distribution plan; k1 is a first penalty coefficient, k2 is a second penalty coefficient, and y₁ᵢ is a value of y1 corresponding to the i-th secondary wastewater initial distribution plan; y₂ᵢ is a value of y2 corresponding to the i-th secondary wastewater initial distribution plan; h3 is cost of make-up water in unit distribution water amount r.

Specifically, the first penalty coefficient and the second penalty coefficient can be set according to the requirements of the environmental protection of water saving. By introducing penalty parameters, it can avoid adding too much new make-up water, reduce the overall water consumption of thermal power plants, and improve the recycling rate of wastewater in thermal power plants.

Specifically, the primary decontamination cost refers to the cost of treating the pollutant content in the current secondary wastewater to the level that it can be reused in the secondary circulation sub-region. The secondary decontamination cost refers to the cost of treating the pollutant content in the current secondary wastewater to the level that it can be reused in the next node region.

Based on another preferred embodiment of the method for treating wastewater from a thermal power plant in any of the above preferred embodiments, a system for treating wastewater from a thermal power plant is provided in this preferred embodiment, including:
a central control unit, used for building multiple wastewater sub-regions and generating pollution evaluation values according to historical parameters of the wastewater sub-regions;
a monitoring unit, used for setting cycle grade and monitoring time nodes of each of the wastewater sub-regions according to the pollution evaluation values,
where the monitoring unit is further used for obtaining water quality monitoring parameters of the wastewater sub-regions according to the monitoring time nodes;
where the central control unit includes:
a first treatment module, used for generating pollution evaluation values;
a second treatment module, used for setting cycle grade of each of the wastewater sub-regions;
a third treatment module, used for building a wastewater control model among the wastewater sub-regions, and setting wastewater treatment parameters of each of the wastewater sub-regions according to the wastewater control model and the water quality monitoring parameters;
where the first treatment module is further used for:
building a wastewater sub-region sequence A, and A=(a1, a2 . . . an), where n is a number of the wastewater sub-regions and ai is i-th wastewater sub-region;
building multiple water quality evaluation indexes;
sequentially selecting target wastewater sub-regions, and building a reference evaluation value sequence B of the target wastewater sub-regions according to historical parameters of the target wastewater sub-regions, and B=(b1, b2 . . . bm), where bi is a reference evaluation value corresponding to i-th water quality evaluation index in wastewater of the target wastewater sub-regions, and m is a number of water quality evaluation indexes;
generating a pollution evaluation value c of the target wastewater sub-regions according to the reference evaluation value sequence B;

$$c = {\sum }_{1}^{i = m} β i * bi ,$$

where βi is influence factor of i-th water quality evaluation index;
where the second treatment module is further used for:
building a pollution evaluation value sequence C, and C=(c1, c2 . . . cn), where ci is a pollution evaluation value of i-th wastewater sub-region;
presetting a first pollution evaluation value threshold C1 and a second pollution evaluation value threshold C2, and C1<C2;
if ci<C1, the i-th wastewater sub-region is set as a primary circulation sub-region;
if C1≤ci<C2, the i-th wastewater sub-region is set as a secondary circulation sub-region;
if ci≥C2, the i-th wastewater sub-region is set as a three-level circulation sub-region.

Specifically, the third treatment module is further used for:
building a wastewater flow direction relationship tree according to device parameters and cycle grade of each of the wastewater sub-regions;
building a primary wastewater model, and setting wastewater parameters of each of primary circulation sub-regions according to the primary wastewater model;
building a secondary wastewater model, and setting wastewater treatment parameters of each of secondary circulation sub-regions according to the secondary wastewater model;
building a three-level wastewater model, and setting wastewater treatment parameters of each of three-level circulation sub-regions according to the three-level wastewater model.

According to the first concept of the disclosure, according to the process flow of the thermal power plant, multiple wastewater points are set, and the wastewater points are classified according to the degree of wastewater pollution, so that the internal water of the thermal power plant is managed in a unified way, and the wastewater discharge in the whole plant area is reduced, thereby reducing the water cost of the thermal power plant.

According to the second concept of the disclosure, by dividing the three-level circulation sub-regions, the cascade utilization is realized according to the water quality classification and reuse of different wastewater. Through the recycling of wastewater, the recovery rate is improved, and the water supply in the plant area is reduced, thus reducing the operation and maintenance cost within the plant area.

The above is only the preferred embodiment of the disclosure, and it should be pointed out that for the ordinary skilled in the field, several improvements and substitutions can be made without departing from the technical principles of this disclosure, and these improvements and substitutions should also be regarded as the protection scope of the disclosure.

1. A method for treating wastewater from a thermal power plant, comprising:
setting a plurality of wastewater points according to a process flow;
classifying each of the plurality of wastewater points into a plurality of wastewater sub-regions according to a degree of wastewater pollution, and generating pollution evaluation values according to historical parameters of the wastewater sub-regions;
setting cycle grade and monitoring time nodes of each of the wastewater sub-regions according to the pollution evaluation values, and obtaining water quality monitoring parameters of the wastewater sub-regions according to the monitoring time nodes;
building a wastewater control model among the wastewater sub-regions, and setting wastewater treatment parameters of each of the wastewater sub-regions according to the wastewater control model and the water quality monitoring parameters;
wherein generating pollution evaluation values comprises:
building a wastewater sub-region sequence A, and A=(a1, a2 . . . an), wherein n is a number of the wastewater sub-regions and ai is i-th wastewater sub-region;
building a plurality of water quality evaluation indexes;
sequentially selecting target wastewater sub-regions, and building a reference evaluation value sequence B of the target wastewater sub-regions according to historical parameters of the target wastewater sub-regions, and B=(b1, b2 . . . bm), wherein bi is a reference evaluation value corresponding to i-th water quality evaluation index in wastewater of the target wastewater sub-regions, and m is a number of water quality evaluation indexes;
generating a pollution evaluation value c of the target wastewater sub-regions according to the reference evaluation value sequence B;
$$c = {\sum }_{1}^{i = m} β i * bi ,$$
wherein β is influence factor of i-th water quality evaluation index;
wherein setting cycle grade of each of the wastewater sub-regions comprises:
building a pollution evaluation value sequence C, and C=(c1, c2 . . . cn), wherein ci is a pollution evaluation value of i-th wastewater sub-region;
presetting a first pollution evaluation value threshold C1 and a second pollution evaluation value threshold C2, and C1<C2;
if ci<C1, setting the i-th wastewater sub-region as a primary circulation sub-region;
if C1≤ci<C2, setting the i-th wastewater sub-region as a secondary circulation sub-region;
if ci≥C2, setting the i-th wastewater sub-region as a three-level circulation sub-region;
wherein building a wastewater control model among the wastewater sub-regions comprises:
building a wastewater flow direction relationship tree according to device parameters and cycle grade of each of the wastewater sub-regions;
building a primary wastewater model, and setting wastewater parameters of each of primary circulation sub-regions according to the primary wastewater model;
building a secondary wastewater model, and setting wastewater treatment parameters of each of secondary circulation sub-regions according to the secondary wastewater model; and
building a three-level wastewater model, and setting wastewater treatment parameters of each of three-level circulation sub-regions according to the three-level wastewater model.

2. The method for treating wastewater from a thermal power plant according to claim 1, wherein setting wastewater parameters of each of primary circulation sub-regions comprising:
building a primary circulation sub-region sequence A1, and A1=(a11, a12 . . . a1n1), wherein a1i is i-th primary circulation sub-region and n1 is a number of primary circulation sub-regions;
sequentially selecting target primary circulation sub-regions;
generating a cycle period of the target primary circulation sub-regions according to monitoring time nodes of the target primary circulation sub-regions;
building a pollutant accumulation model, and generating a cycle number interval (E1, E2) of the target primary circulation sub-regions according to the pollutant accumulation model, wherein E1 is a first cycle number and E2 is a second cycle number;
when wastewater cycle number E1<e<E2 in the target primary circulation sub-regions, generating primary wastewater discharge amount Q1 in the target primary circulation sub-regions;
obtaining a next node region of the target primary circulation sub-regions according to the wastewater flow direction relationship tree, and generating primary wastewater demand Q2 of the next node region of the target primary circulation sub-regions;
if Q1<Q2, transporting all primary wastewater in the target primary circulation sub-regions is to next node region, and resetting wastewater circulation number e;
if Q1>Q2, transporting primary wastewater in the target primary circulation sub-regions to the next node region according to the primary wastewater demand Q2; and
when the wastewater cycle number e>E2 in the target primary circulation sub-regions, generating a primary storage instruction.

3. The method for treating wastewater from a thermal power plant according to claim 2, wherein setting wastewater treatment parameters of each of secondary circulation sub-regions comprising:
building a secondary circulation sub-region sequence A2, and A2=(a21, a22 . . . a2n2), wherein n2 is a number of secondary circulation sub-regions and a2i is i-th secondary circulation sub-region;
sequentially selecting target secondary circulation sub-regions;
obtaining water quality monitoring parameters according to monitoring time nodes of the target secondary circulation sub-regions, and generating secondary wastewater amount P2 and secondary wastewater pollution degree of the target secondary circulation sub-regions;
obtaining a previous node region and a next node region of each of the target secondary circulation sub-regions according to the wastewater flow direction relationship tree;
obtaining primary wastewater supply P1 of the previous node region and the third-level wastewater demand P3 of the next node region;
generating a plurality of secondary wastewater initial distribution plans from primary wastewater supply P1, the secondary wastewater amount P2 and the third-level wastewater demand P3 according to a preset constraint model;
building a cost optimization model, and generating expected cost of each of the secondary wastewater initial distribution plans according to the cost optimization model; and
building a expected cost sequence F, and F=(f1, f2 . . . fm1), wherein m1 is a number of the secondary wastewater initial distribution plans and fi is i-th secondary wastewater initial distribution plan.

4. The method for treating wastewater from a thermal power plant according to claim 3, wherein generating a plurality of secondary wastewater initial distribution plans comprises:
building a constraint model:
$$\{ \begin{matrix}r 1 + r 2 = P 2 \\ r 1 + r 3 + y 1 \geq P 2 \\ r 3 \leq P 1 \\ r 2 + y 2 \geq P 3\end{matrix} ;$$
wherein r1 is a secondary wastewater amount performing circulation and r2 is a secondary wastewater amount flowing to next node region; r3 is a primary wastewater amount flowing to secondary circulation sub-region; y1 is a compensation water amount to be injected into the target secondary circulation sub-regions, and y2 is a compensation water amount to be injected into the next node region;
setting a unit distribution water amount r, and solving constraint equation according to the unit distribution water amount r; and
generating one of the secondary wastewater initial distribution plans according to single group feasible solutions of r1, r2, r3, y1 and y2.

5. The method for treating wastewater from a thermal power plant according to claim 4, wherein generating expected cost of each of the secondary wastewater initial distribution plans comprises:
$$fi = h {1}^{*} {r}_{1 i} + h {2}^{*} {r}_{2 i} + k {1}^{*} {y}_{1 {i}^{*}} h 3 + k {2}^{*} {y}_{2 {i}^{*}} h 3 ;$$
and
wherein fi is expected cost of i-th secondary wastewater initial distribution plan, h1 is primary decontamination cost of secondary wastewater in unit distribution water amount r, and r1i is a value of r1 corresponding to i-th secondary wastewater initial distribution plan; h2 is secondary decontamination cost of secondary wastewater in the unit distribution water amount r; r2i is a value of r2 corresponding to the i-th secondary wastewater initial distribution plan; k1 is a first penalty coefficient, k2 is a second penalty coefficient, and y1i is a value of y1 corresponding to the i-th secondary wastewater initial distribution plan; y2i is a value of y2 corresponding to the i-th secondary wastewater initial distribution plan; h3 is cost of make-up water in unit distribution water amount r.

6. A system for treating wastewater from a thermal power plant, using the thermal power plant wastewater treatment method according to claim 1, comprising:
a central control unit, used for building a plurality of wastewater sub-regions and generating pollution evaluation values according to historical parameters of the wastewater sub-regions; and
a monitoring unit, used for setting cycle grade and monitoring time nodes of each of the wastewater sub-regions according to the pollution evaluation values,
wherein the monitoring unit is further used for obtaining water quality monitoring parameters of the wastewater sub-regions according to the monitoring time nodes;
wherein the central control unit comprises:
a first treatment module, used for generating pollution evaluation values;
a second treatment module, used for setting cycle grade of each of the wastewater sub-regions; and
a third treatment module, used for building a wastewater control model among the wastewater sub-regions, and setting wastewater treatment parameters of each of the wastewater sub-regions according to the wastewater control model and the water quality monitoring parameters;
wherein the first treatment module is further used for:
building a wastewater sub-region sequence A, and A=(a1, a2 . . . an), wherein n is a number of the wastewater sub-regions and ai is i-th wastewater sub-region;
building a plurality of water quality evaluation indexes;
sequentially selecting target wastewater sub-regions, and building a reference evaluation value sequence B of the target wastewater sub-regions according to historical parameters of the target wastewater sub-regions, and B=(b1, b2 . . . bm), wherein bi is a reference evaluation value corresponding to i-th water quality evaluation index in wastewater of the target wastewater sub-regions, and m is a number of water quality evaluation indexes;
generating a pollution evaluation value c of the target wastewater sub-regions according to the reference evaluation value sequence B;
$$c = {\sum }_{1}^{i = m} β i * bi ,$$
wherein β i is influence factor of i-th water quality evaluation index;
wherein the second treatment module is further used for:
building a pollution evaluation value sequence C, and C=(c1, c2 . . . cn), wherein ci is a pollution evaluation value of i-th wastewater sub-region; and
presetting a first pollution evaluation value threshold C1 and a second pollution evaluation value threshold C2, and C1<C2;
if ci<C1, setting the i-th wastewater sub-region as a primary circulation sub-region;
if C1≤ci<C2, setting the i-th wastewater sub-region as a secondary circulation sub-region; and
if ci≥C2, setting the i-th wastewater sub-region as a three-level circulation sub-region.

7. The system for treating wastewater from a thermal power plant according to claim 6, wherein the third treatment module is further used for: building a wastewater flow direction relationship tree according to device parameters and cycle grade of each of the wastewater sub-regions;
building a primary wastewater model, and setting wastewater parameters of each of primary circulation sub-regions according to the primary wastewater model;
building a secondary wastewater model, and setting wastewater treatment parameters of each of secondary circulation sub-regions according to the secondary wastewater model; and
building a three-level wastewater model, and setting wastewater treatment parameters of each of three-level circulation sub-regions according to the three-level wastewater model.
